(19) United States
(12) Patent Application Publication
(10) Pub. No.: US 2022/0215316 A1
(43) Pub. Date: Jul. 7, 2022

(54) SYSTEMS AND METHODS FOR GENERATING MICROSITES AND MONITORING CUSTOMER EXPERIENCE THEREOF

(71) Applicant: CXera, Inc., Edina, MN (US)

(72) Inventors: Craig NELSON, Edina, MN (US); Mark Edward TASSEEL, Bishop's Stortford (GB); Vlado SKOKO, Belgrade (RS); Michael Harold CROSS, Rancho Palos Verdes, CA (US)

(21) Appl. No.: 17/567,871

(22) Filed: Jan. 3, 2022

Related U.S. Application Data
(60) Provisional application No. 63/133,546, filed on Jan. 4, 2021.

(51) Int. Cl. G06Q 10/06; G06Q 30/06; G06Q 30/02; G06F 9/451

(52) U.S. Cl. CPC G06Q 10/06393; G06F 9/453; G06Q 30/0282; G06Q 30/0609

(57) ABSTRACT

Embodiments of the present disclosure provide systems and methods for generating a microsite and monitoring customer experience thereof. The method performed by a server system includes receiving a service request for accessing microsite services. The method includes rendering a wizard suite associated with the microsite services for enabling a user to create the microsite of a source webpage. Further, the method includes receiving one or more microsite parameters associated with the wizard suite based on user inputs in the wizard suite. The microsite parameters include a microsite type and a microsite template including a plurality of dynamic microsite elements. The method further includes receiving content data of the source webpage to be populated in corresponding dynamic microsite element of the microsite template. The method includes generating the microsite of the source webpage based at least on a combination of the one or more micro site parameters and the content data.

### TECHNICAL FIELD

The present disclosure relates to microsite generation and customer experience monitoring and, more particularly to, computerized systems and methods for microsite generation and monitoring customer experience thereof.

### BACKGROUND

A microsite is an individual web page or cluster of pages that are meant to function as a discrete entity within an existing website or to complement another software as a service (SaaS) solution and activity.

In recent times, there have been various kinds of implementations to partially replicate the contents of a parent website (or source webpages) or to complement an offline activity. Typically, users (for example, content providers, advertisement managers, etc.) rely on microsites to provide targeted and specialized content containing highly focused information than the parent website (or source webpages). Accordingly, the microsites may include independent domains or subdomains apart from the source webpages.

In one example scenario, companies and/or enterprises managing the source webpages often use microsites to enhance the user experience and provide targeted information to those visiting the microsites. The microsites offer the companies to drive sales or traffic to the webpages by providing valuable content in the microsites. However, generating and publishing microsites using existing systems and methods involve a significant amount of effort and time. Additionally, operations such as generating, publishing, and maintenance of the microsites require technical knowledge by information technology (IT) professionals of the platforms associated with the source webpages. For example, after generation of the microsite, maintenance of the microsite is an intricate task because of various components involved in generation of the microsite. Additionally, companies and/or enterprises continuously keep on looking for methods to enhance the user experience. Thus, due to the aforementioned constraints, the enterprises may underutilize the microsites and therefore lead to reduced ability to reach users which in turn affects the business services of the enterprises. In some cases, the users may be rendered with microsites that may be intrusive and/or irrelevant to the users. Typically, the existing systems and methods may be inefficient in tracking and analyzing user preferences (or interests) to provide valuable content to the users.

Thus, there exists a need for technical solutions for generating the microsites, monitoring user experience, and providing recommendations to enhance the user experience thereof, to provide effective handoff from sales to service and customer success.

### SUMMARY

Various embodiments of the present disclosure provide computerized systems and methods for microsite generation and monitoring customer experience thereof.

In an embodiment, a computer-implemented method is disclosed. The computer-implemented method performed by a server system includes receiving a service request for accessing microsite services associated with the server system. The service request is transmitted from an application available on a user device associated with a user. The method includes rendering a wizard suite associated with the microsite services in the application for enabling the user to create a microsite of a source webpage. Further, the method includes receiving one or more microsite parameters associated with the wizard suite based at least on user inputs in the wizard suite. The one or more microsite parameters include one of a microsite type and a microsite template including a plurality of dynamic microsite elements. The method further includes receiving content data of the source webpage to be populated in corresponding dynamic microsite elements of the one or more dynamic microsite elements of the microsite template. The method includes generating the microsite of the source webpage based, at least in part, on a combination of the one or more micro site parameters and the content data.

In another embodiment, a server system is disclosed. The server system includes a communication interface, a memory including executable instructions, and a processor communicably coupled to the communication interface and the memory. The processor is configured to cause the server system to perform at least receive a service request for accessing microsite services associated with the server system. The service request is transmitted from an application available on a user device associated with a user. The server system is caused to render a wizard suite associated with the microsite services in the application for enabling the user to create a microsite of a source webpage. Further, the server system is caused to receive one or more microsite parameters associated with the wizard suite based at least on user inputs in the wizard suite. The one or more microsite parameters include one of a microsite type and a microsite template including a plurality of dynamic microsite elements. The server system is further caused to receive content data of the source webpage to be populated in corresponding dynamic microsite elements of the one or more dynamic microsite elements of the microsite template. The server system is caused to generate the microsite of the source webpage based, at least in part, on a combination of the one or more microsite parameters and the content data.

### BRIEF DESCRIPTION OF THE FIGURES

The following detailed description of illustrative embodiments is better understood when read in conjunction with the appended drawings. For the purpose of illustrating the present disclosure, exemplary constructions of the disclosure are shown in the drawings. However, the present disclosure is not limited to a specific device, or a tool and instrumentalities disclosed herein. Moreover, those in the art will understand that the drawings are not to scale. Wherever possible, like elements have been indicated by identical numbers:

FIG. 1 illustrates an exemplary representation of an environment related to at least some embodiments of the present disclosure;

FIG. 2A is a simplified block diagram of a server system for generating a microsite and monitoring customer experience with the microsite, in accordance with an embodiment of the present disclosure;

FIG. 2B illustrates a simplified block diagram representation of a system architecture for generating the microsite and monitoring customer experience with the microsite, in accordance with an example embodiment of the present disclosure;

FIG. 3A illustrates a simplified block diagram representation of a system architecture associated with a microsite management system, in accordance with an example embodiment of the present disclosure;

FIG. 3B illustrates a simplified block diagram representation depicting integrations of various entities with the microsite management system, in accordance with an example embodiment of the present disclosure;

FIGS. 4A-4H, collectively, represent example representation of user interfaces (UIs) rendered in the application for generating the microsite, in accordance with an example embodiment of the present disclosure;

FIGS. 5A and 5B, collectively, represent example representation of user interfaces (UIs) rendered in the application for monitoring the customer experience with the microsite, in accordance with an example embodiment of the present disclosure;

FIG. 6 illustrates a flow diagram of a computer-implemented method for generating the microsite, in accordance with an embodiment of the present disclosure; and

FIG. 7 is a simplified block diagram of an electronic device capable of implementing various embodiments of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

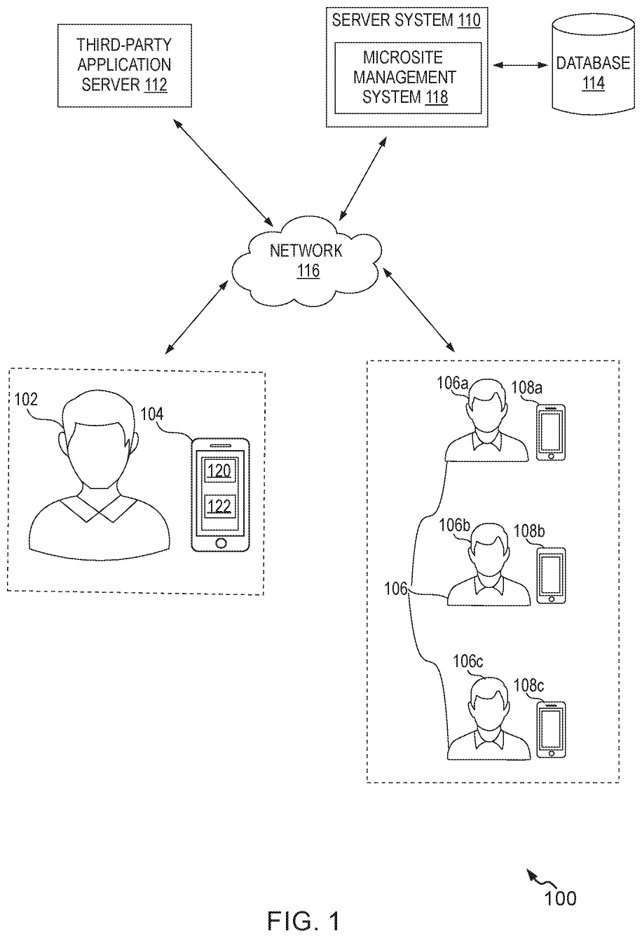

Various embodiments of the present invention are described hereinafter with reference to FIG. 1 to FIG. 7.

FIG. 1 illustrates an exemplary representation of an environment 100 related to at least some example embodiments of the present disclosure. Although the environment 100 is presented in one arrangement, other embodiments may include the parts of the environment 100 (or other parts) arranged otherwise depending on, for example, creating microsites and monitoring customer experience with the microsites. The environment 100 generally includes a plurality of entities, for example, a user device 104 associated with a user 102, a plurality of customers 106 (collectively referred for a customer 106a, a customer 106b and a customer 106c), associated with a user device 108a, a user device 108b and a user device 108c, respectively, a server system 110 and a third-party application server 112 each coupled to, and in communication with (and/or with access to) a network 116. The network 116 may include, without limitation, a light fidelity (Li-Fi) network, a local area network (LAN), a wide area network (WAN), a metropolitan area network (MAN), a satellite network, the Internet, a fiber-optic network, a coaxial cable network, an infrared (IR) network, a radio frequency (RF) network, a virtual network, and/or another suitable public and/or private network capable of supporting communication among the entities illustrated in FIG. 1, or any combination thereof.

Various entities in the environment 100 may connect to the network 116 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, or any combination thereof. For example, the network 116 may include multiple different networks, such as a private network made accessible by the server system 110, separately, and a public network (e.g., the Internet).

In one example scenario, the user 102 may be a representative of a particular enterprise, business, advertisement agency, marketing, services, customer success, and the like. The user 102 may be referred to as creator. The user 102 may avail microsite services offered by a microsite management system 118 associated with the server system 110 for generating a customer-centric microsite based on a source webpage associated with the enterprise or business services. Further, the customers 106 may access the microsite in their respective user device 108a-108c, once the microsite is published, therefore improving a handoff experience from sales to services success. Some examples of the user devices 104 and 108a-108c may include, but are not limited to, laptops, smartphones, desktops, tablets, workstation terminals, an Ultra-Mobile personal computer (UMPC), a phablet computer, a handheld personal computer, and the like.

In an embodiment, the user device 104 is equipped with an instance of an application 120. The application 120 is hosted and managed by the server system 110, for creating the microsite from a source webpage (or website). The application 120 is a set of computer-executable codes configured to provide user interfaces (UIs) enabling the user 102 to create the microsite and monitor the customer experience thereof, which will be explained further in detail. In an embodiment, the microsite management system 118 associated with the server system 110 may provide the application 120, in response to a request received from the user device 104 via the network 116. In another embodiment, the application 120 may be factory-installed on the user device 104. In some embodiments, the server system 110 may provide the application 120 as a web service accessible through a website. In such a scenario, the application 120 may be accessed through the website over the network 116 using a web browser application (e.g., Google Chrome, Safari, Mozilla Firefox, Opera, Microsoft Edge, etc.) installed in the user device 104.

In at least one embodiment, the application 120 may be accessed through a third-party application 122 hosted and managed by a third-party application server 112 via the network 116. Examples of the third-party application 122 may include, but are not limited to, Zoom meeting, Salesforce, and the like. Typically, the third-party application 122 creates a contractual agreement with the application 120 to comply with the privacy and security requirements of the application 120. Based on the contractual agreement, the server system 110 including the microsite management system 118 may provide access to the microsite services for the third-party application server 112 through integrated application programming interface (API) services. In other words, the application 120 may be a plugin for the third-party application 122. In some embodiments, the application 120 can be implemented as operating system extensions, module, plugins, and the like. Further, the application 120 may be operative in cloud infrastructure, or the application 120 may be executed within or as a virtual machine (VM) or virtual server that may be managed in the cloud infrastructure.

The server system 110 is embodied in at least one computing device in communication with the network 116 and/or embodied in at least one non-transitory computer-readable media. In one embodiment, the server system 110 is configured to perform one or more of the operations described herein. In particular, the microsite management system 118 associated with the server system 110 is configured to generate the microsite in a limited period of time (e.g., in several minutes) based on customer information gathered over weeks or months. Further, the microsite management system 118 continuously monitors the customer experience with the microsite for providing effective handoff from sales to services. The server system 110 including the microsite management system 118 is a separate part of the environment 100 and may operate apart from (but still in communication with, for example, via the network 116) any third party external servers such as the third-party application server 112 (to access data to perform the various operations described herein).

In an embodiment, the server system 110 may include one or more databases, such as a database 114. In an embodiment, the database 114 may be a separate entity (or an external database) that is in communication with the server system 110 via the network 116. The database 114 may be configured to store the microsite-related components such as, but not limited to, microsite templates, microsite creation tools, customer-related data, and user-related data.

The microsite management system 118 associated with the server system 110 is configured to receive a service request for accessing the microsite services from the application 120. The user 102 may provide inputs in the application 120 to avail the microsite services associated with the server system 110, which in turn, triggers the service request to the server system 110. The microsite management system 118 provides a wizard suite in the application 120 based on authenticating the user 102. The microsite management system 118 may authenticate the user 102 based at least on user credentials (e.g., email address) of the user 102. In other words, the microsite management system 118 may determine the user 102 as a licensed user based on the user credentials for providing the wizard suite in the application 120. The wizard suite is a simple-to-use microsite wizard that guides the creator (e.g., the user 102) step-by-step through the creation of the micro site and deploying the microsite within a limited period of time (e.g., within minutes). Further, the wizard suite allows the user 102 to generate the microsite without the need for technical knowledge about information technology (IT) associated with the microsite generation.

More specifically, the user 102 selects one or more microsite parameters (e.g., predefined templates, microsite type, microsite layout, etc.) of the wizard suite rendered in the application 120 and provides content data (or content) to the microsite management system 118. Further, the microsite management system 118 generates the microsite based on the combination of the microsite parameters selected by the user 102 in the wizard suite and the content data. In one implementation, the wizard suite allows the user 102 to generate various types of microsites, such as, but not limited to, a contact microsite, an event microsite, a deal microsite, and an onboarding microsite. In one example, the wizard suite allows the user 102 to generate various other types of microsites such as e-commerce microsite, educational microsite, entertainment microsite, portfolio microsite, social media microsite, or any other microsite of the like. The microsite management system 118 further publishes and/or activates the microsite. As such, the customers 106 can access the microsite seamlessly at their respective user device (i.e., the user devices 108a-108c) through a business webpage, email, or any other applications. Thus, it is understood that the microsite management system 118 delivers a holistic Everboarding approach to ensure customer success. In general, the term “Everboarding” may refer to delivering personalized and trackable web-based service or mobile application (e.g., the application 120) to deliver resources and track progress through all onboarding services such as checklists, surveys, ratings, document sharing, and other services required to enhance customer experience.

In another embodiment, the microsite management system 118 may provide various microsite generation techniques for microsite generation such as, but not limited to, clone operation, one-click operation, integration with third-party applications (for example, the third-party application 122 hosted and managed by the third-party application server 112) and other applications available on the user device (e.g., a mobile phone). In one embodiment, the microsite management system 118 associated with the server system 110 receives a service request for converting the microsite belonging to a particular microsite type (e.g., onboarding microsite) into another microsite belonging to other microsite types (e.g., contact microsite).

Further, the microsite management system 118 allows the user 102 to generate guides for the end user (i.e., the customers 106) to get through a customer experience process. More specifically, the microsite management system 118 provides analytics to the user 102 based on continuously tracking interactions of each of the customers 106 with the microsite. Additionally, the microsite management system 118 may be configured to evaluate a feedback score indicative of a customer rating on the microsite based at least on the interaction of the customers 106 with the microsite. Thereafter, the microsite management system 118 is configured to provide both automated and recommended updates to the microsite based on monitoring the interaction of the customers 106 with the microsite. In other words, the microsite management system 118 is configured to detect a customer's dissatisfaction at an early stage to provide corrective actions and recommendations to the microsite for assisting the customers 106 from first customer contact till continued customer success.

The microsite management system 118 associated with the server system 110 is configured to schedule the publishing of the microsite to the customers 106 based at least on a temporal restriction. Additionally, the microsite management system 118 may be configured to incorporate a level of game mechanics to cover both peer-to-peer recognition as well as manager recognition, to increase microsite adoption and engagement which will be explained further in detail.

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices. Additionally, or alternatively, a set of systems (e.g., one or more systems) or a set of devices (e.g., one or more devices) of the environment 100 may perform one or more functions described as being performed by another set of systems or another set of devices of the environment 100.

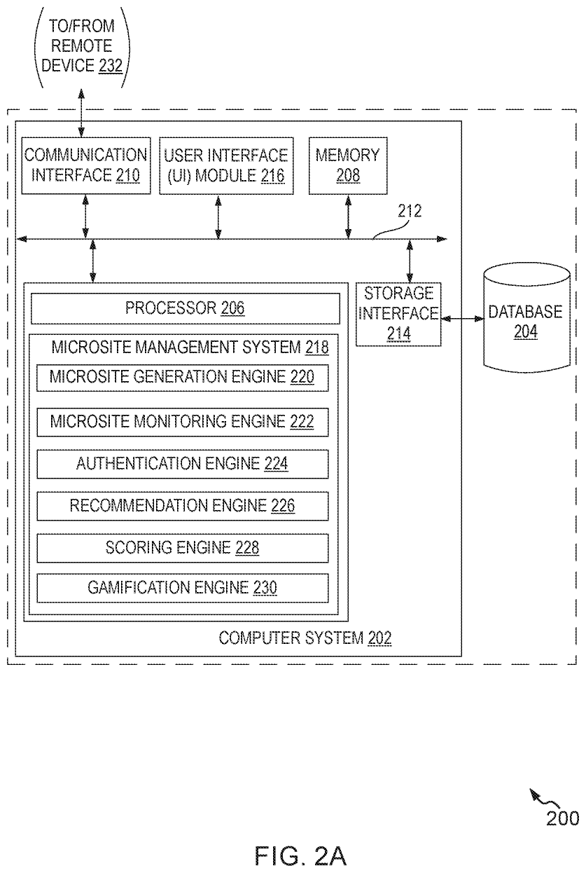

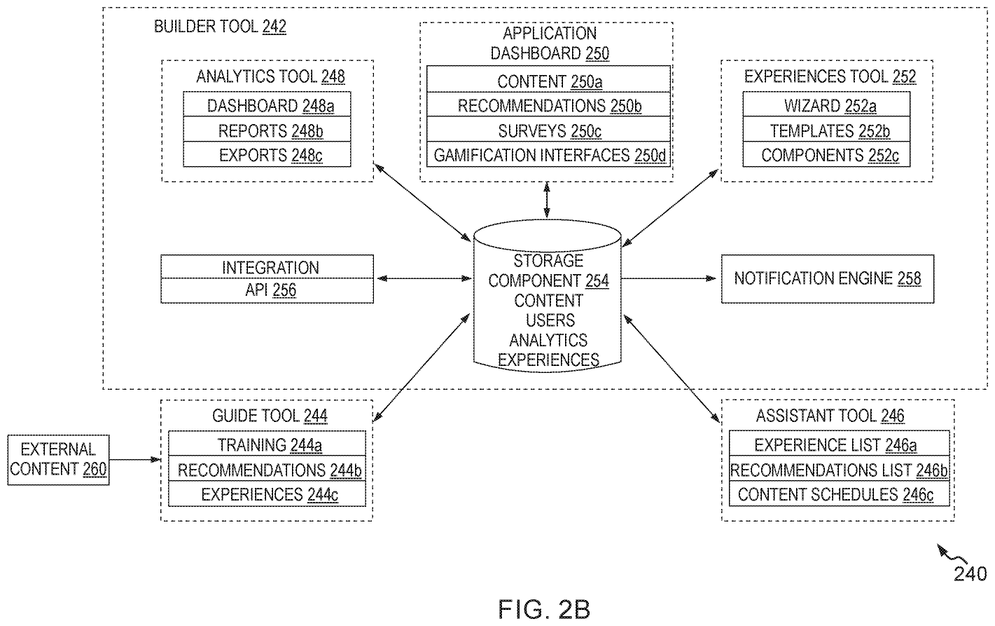

FIG. 2A is a simplified block diagram of a server system 200, in accordance with an embodiment of the present disclosure. The server system 200 is an example of the server system 110 of FIG. 1. In some embodiments, the server system 200 is embodied as a cloud-based and/or SaaS-based (software as a service) architecture. Typically, the server system 200 may use pipeline architectures for facilitating the creation of the microsite within a limited period of time and monitoring the customer experience with the microsite.

The server system 200 includes a computer system 202 and a database 204. The computer system 202 includes at least one processor 206 for executing instructions, a memory 208, a communication interface 210, a storage interface 214, and a user interface (UI) module 216 that communicate with each other via a centralized circuit system 212.

In some embodiments, the database 204 is integrated within computer system 202. For example, the computer system 202 may include one or more hard disk drives as the database 204. In one embodiment, the database 204 is integrated within the computer system 202 and configured to store an instance of the application 120 and one or more components of the application 120. The one or more components of the application 120 may be, but not limited to, one or more tools associated with the application 120, wizard suite, predefined microsite templates, content-related data, user-related data, game mechanics (or gaming attributes), and the like. The storage interface 214 is any component capable of providing the processor 206 with access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204.

The UI module 216 is in communication with the database 204. The UI module 216 is configured to present one or more UIs at the user device 104 for facilitating the creation of the microsite, monitoring analytics based on the customer experience with the microsite, and the like. Typically, the UI module 216 allows the server system 200 to communicate with the application 120 in the user device 104 for facilitating the creation of the microsite using the microsite parameters associated with the wizard suite of the application 120.

The processor 206 includes a suitable logic, circuitry, and/or interfaces to execute computer-readable instructions for performing one or more operations to generate the microsite and monitor the customer experience with the microsite. Examples of the processor 206 include, but are not limited to, an application-specific integrated circuit (ASIC) processor, a reduced instruction set computing (RISC) processor, a complex instruction set computing (CISC) processor, a field-programmable gate array (FPGA), and the like. The memory 208 includes suitable logic, circuitry, and/or interfaces to store a set of computer-readable instructions for performing operations. Examples of the memory 208 include a random-access memory (RAM), a read-only memory (ROM), a removable storage drive, a hard disk drive (HDD), and the like. It will be apparent to a person skilled in the art that the scope of the disclosure is not limited to realizing the memory 208 in the server system 200, as described herein. In another embodiment, the memory 208 may be realized in the form of a database server or cloud storage working in conjunction with the server system 200, without departing from the scope of the present disclosure.

The processor 206 is operatively coupled to the communication interface 210 such that the processor 206 is capable of communicating with a remote device 232 such as, the user devices 104, and 108a-108c and the third-party application server 112 or communicated with any entity connected to the network 116 (as shown in FIG. 1).

It is noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2A.

In one embodiment, the server system 200 includes the processor 206 and a microsite management system 218. The microsite management system 218 is an example of the microsite management system 118 of FIG. 1. The microsite management system 218 includes a microsite generation engine 220, a microsite monitoring engine 222, an authentication engine 224, a recommendation engine 226, a scoring engine 228, and a gamification engine 230. It should be noted that components, described herein, can be configured in a variety of ways, including electronic circuitries, digital arithmetic and logic blocks, and memory systems in combination with software, firmware, and embedded technologies.

The microsite generation engine 220 includes suitable logic and/or interfaces for facilitating the user 102 to create the microsite of the source webpage within a limited period of time (e.g., within several minutes). More specifically, the microsite generation engine 220 may receive a service request for accessing the microsite services associated with the server system 200. It is to be noted that the service request may be triggered from the application (such as the application 120) available on the user device 104 based on user inputs related to accessing the microsite services for generating the microsite for the customers (i.e., the customers 106).

In one implementation, the microsite management system 218 performs authentication of the user 102 and/or the third-party applications (e.g., the third-party application 122) to allow access to the microsite services associated with the server system 200. Further, authentication of the user 102 and the third-party applications for allowing access to the microsite services will be explained further in detail.

Upon successful authentication, the microsite management system 218 facilitates the microsite generation engine 220 to render the wizard suite associated with the application 120 at the user device 104. The user 102 provides inputs in the wizard suite for creating the microsite of the source webpage. The wizard suite guides the user 102 step-by-step for creating the microsite of the source webpage in a hassle-free manner.

More specifically, the user 102 selects the one or more microsite parameters associated with the wizard suite for creating the microsite. The parameters may include, but are not limited to, a microsite type and a microsite template, a plurality of dynamic microsite elements, and the like. The microsite generation engine 220 facilitates the wizard suite to render a list of microsite types for user selection. The user 102 selects the microsite type based at least on his/her business and the customer needs. In other words, the microsite template is selected by the user 102 to generate the microsite optimized for a particular goal. The microsite types associated with the wizard suite may include, but are not limited to, the contact microsite, the deal microsite, the event microsite, and the onboarding microsite. Upon selection of the microsite type, the microsite generation engine 220 receives input related to the selection of the microsite template in the wizard suite. The microsite template may be predefined for each type of microsite and stored in the database 204. In one embodiment, the microsite generation engine 220 facilitates the user 102 to create the microsite template based on providing inputs in the wizard suite.

In one embodiment, the microsite generation engine 220 receives a service request for converting the microsite belonging to a particular microsite type (e.g., deal microsite) into another microsite belonging to other microsite types (e.g., onboarding microsite). The service request may be received from the user 102 through the application 120 installed in the user device 104. Based on the service request, the microsite generation engine 220 renders the wizard suite to enable the user 102 to convert the deal microsite into the onboarding microsite.

The microsite template includes the plurality of dynamic microsite elements. The dynamic microsite elements may act as micro-apps, which are intended to perform specific functions in the microsite. Examples of the dynamic microsite elements in the microsite template may include, but are not limited to, a welcome banner, graphics, video clips, user analytics, and surveys. Further, the dynamic microsite elements are configured to connect to other SaaS solutions to dynamically receive and transmit information. The microsite generation engine 220 facilitates the user 102 to edit and/or customize the dynamic microsite elements in the microsite template according to the user preferences. In one embodiment, the microsite generation engine 220 may facilitate the user 102 to customize the dynamic microsite elements (user-defined dynamic microsite elements) by providing inputs in the wizard suite and including the user-defined dynamic microsite elements in the microsite template.

Additionally, the microsite generation engine 220 may receive user inputs related to providing access to the microsite to various user devices. For instance, the user 102 may specify whether the microsite is intended for either a tablet device, or a personal computer (PC), or a mobile device. To that effect, the microsite generation engine 220 is configured to customize and/or organize a layout format of the microsite template based on the set preferences related to the accessibility of the microsite from various user devices (either the tablet device, the mobile phone, or the like). For instance, the operations performed by the microsite generation engine 220 to customize the layout format may include: a) adapting a color theme of the microsite based on user inputs, b) a location of the dynamic microsite elements in the microsite, and the like. Thereafter, the microsite generation engine 220 is configured to design the microsite based at least on the aforementioned inputs.

Further, the microsite generation engine 220 is configured to receive the content data related to the source webpage. The content data may be a set of data of the source webpage to be included in the corresponding dynamic microsite element of the microsite. The content data provides information about the source webpage in a superficial manner. The microsite generation engine 220 may facilitate the user 102 to provide the content data of the source webpage in the wizard suite. In one embodiment, the microsite generation engine 220 may facilitate the user 102 to access the files containing the content data from various data sources such as, but not limited to, a local storage, existing files within the microsite, or third-parties data storage (such as Google Drive). Additionally, the microsite generation engine 220 in conjunction with a microsite content processor (not shown in FIGS.) may be configured to process the content data of the microsite to be provided thereon. Thereafter, the microsite generation engine 220 generates the microsite of the source webpage based, at least in part, on a combination of the microsite parameters and the content data.

The microsite generation engine 220 is configured to publish the microsite for making it available to the customers 106. More specifically, the user 102 may provide inputs related to a plurality of customers (i.e., the customers 106) based on inputs provided by the user in the wizard suite, the plurality of customers being selected from a list of customers of existing microsites associated with the server system and third-party applications (e.g., the third-party application 122). As explained above, the customer-related data and the user-related data are stored in the database 204. The user 102 selects the customers 106 from the list of customers to provide access to the customers 106 who will use the microsite. Thereafter, the microsite generation engine 220 publishes the microsite including the content data of the source webpage. Thus, the customers 106 can seamlessly access the microsite created by the user 102 at their respective user device (e.g., the user devices 108a-108c). For instance, the customers 106 may access the microsite at their user devices 108a-108c through the business webpage, email application, or any other applications of the user device.

Additionally, the microsite generation engine 220 may facilitate the wizard suite to render a detailed summary of the microsite, prior to deploying the microsite on digital platforms. As such, the user 102 confirms the details of the microsite and may provide details such as, but not limited to, a name for the microsite, visibility status (either public, private or restricted). The microsite generation engine 220 may store the microsite in the database 204 based at least on user confirmation in the details summary.

It is to be noted that the microsite generation engine 220 renders the wizard suite for enabling the user 102 to generate the microsite without the need of technical knowledge about the information technology (IT). The microsite generation engine 220 provides a swift experience for allowing the user 102 to generate and deploy the customer-centric microsite within minutes. Typically, delivering a great customer experience starts at first contact and lasts throughout the customer relationship, which conforms to the Everboarding approach. Thus, the everboarding approach facilitates customer onboarding and ensures an effective handoff from sales to services, and establishes customer value with a microsite. In other words, the Everboarding approach facilitates taking disparate customer microsites and clustering. This allows the users (i.e., the user 102) to address the needs of customers (i.e., the customers 106) from first customer contact with personalized contact sites (or the microsites) to supporting the customers during their evaluation aligned to their needs, to onboarding the customers based on their success criteria.

In one embodiment, the microsite generation engine 220 may be configured to publish the microsite at predetermined time intervals. More specifically, the user 102 may provide the input related to a temporal restriction (e.g., predefined time) for an operation related to rendering the microsite to the customers 106. In such a scenario, the microsite generation engine 220 is configured to publish (or render) the microsite to the customers 106 based, at least in part, on expiry of the predefined time associated with the temporal restriction set of the corresponding operation. In another embodiment, the user 102 may set the temporal restriction for example, a date for publishing and/or rendering the microsite or a task defined on a site for the customers 106. In this scenario, the microsite generation engine 220 publishes the microsite on the specified date or upon completing the task by the customers 106.

As explained above, the microsite generation engine 220 is configured to provide various microsite generation techniques for microsite generation apart from rendering the wizard suite. The various microsite generation techniques may include, but are not limited to, clone operation, one-click operation, integration with third-party applications, and other applications available on the user device (e.g., a mobile phone).

In the case of the clone operation, the microsite generation engine 220 facilitates the user 102 to generate a new microsite from an existing microsite. The new microsite generated from the existing microsite using the clone operation may be assigned with a new name and stored in the database 204 as a microsite template.

In the case of the one-click operation, the microsite generation engine 220 facilitates the creation of the microsite with little or no additional information from the creator (i.e., the user 102). It is to be noted that the microsite generation engine 220 allows the user 102 to use the one-click operation for generating a one-click microsite based at least on determining the user 102 to be a licensed user.

In the case of the third-party applications, the microsite generation engine 220 facilitates the integration of the third-party application (such as the third-party application 122) with the microsite management system 218. In this scenario, the microsite generation engine 220 generates the microsite as part of the users' existing workflow. Further, the microsite generation engine 220 provides the microsite services to be used in the third-party application 122 through the APIs. In one example scenario, the third-party application may be a video communication platform (e.g., zoom meeting) integrated with the server system 200. The processor 206 of the server system 200 is configured to monitor the video communication platform via APIs. The video communication platform may be configured to notify the server system 200 once a meeting raised by the video communication platform has ended. The meeting details may be stored with a timestamp in an event calendar associated with application 120 via the third-party application server 112. The user 102 is directed to the wizard suite based on selecting the calendar entry of the meeting in the event calendar, thereby allowing the user 102 to create the microsite based on the details from the meeting. The user 102 can add the attendees of the meeting created in the video communication platform to the microsite as the users (i.e., the customers 106). Additionally, the user 102 may add other information (such as a meeting transcript, meeting recording, or documents) to the microsite depending on the microsite template. In another example scenario, the third-party application may be a cloud-based software company integrated with the server system 200 for creating the microsite.

In the case of the applications available on the user device (e.g., mobile phone), the microsite generation engine 220 facilitates the user 102 to create a one-tap microsite based on the existing microsite through APIs. It is to be noted that the microsite generated using the applications available on the user device is similar to the one-click operation. In this scenario, the user 102 can and add the customers 106 or select the customers 106 from contacts available in the user device for providing access to the microsite.

The microsite monitoring engine 222 includes suitable logic and/or interfaces for tracking the interaction of the customers 106 with the microsite. In an embodiment, the microsite monitoring engine 222 may be configured to track the interaction of the user 102 with the microsite. As such, the microsite management system 218 is configured to optimize the content data, or the microsite based on monitoring the interaction of at least the user 102 and the customers 106 in the microsite. More specifically, the microsite monitoring engine 222 is configured to continuously monitor one or more metrics associated with the microsite based at least on the interaction of the customers 106 with the microsite. The one or more metrics may include, but are not limited to, a login time to the microsite, an active duration in the microsite, and document-related operations performed in the microsite. In other words, as the customers 106 or the user 102 interact with the microsite (particularly, the dynamic microsite elements, the content data, the game mechanics, and the like), they trigger the metrics, which are recorded by the microsite monitoring engine 222. As such, the user 102 may access the interaction of the customers 106 with the microsite. Further, the microsite management system 218 is configured to optimize and/or provide suggestions to adapt the microsite according to the customer preferences based on analyzing the metrics which will be explained further in detail.

The authentication engine 224 includes suitable logic and/or interfaces for authenticating the user 102 and/or the customers 106 to provide access to the microsite services. More specifically, the authentication engine 224 is configured to perform authentication of the user 102 to provide access to the microsite services for creating the microsite. The authentication engine 224 may authorize the user 102 based on the user credentials (e.g., Internet protocol (IP) address, email address, and the like). Further, the authentication engine 224 is configured perform authentication of the customers 106 being selected by the user 102 from the list of customers based at least on credentials (for example, username or email address) associated with each of the plurality of customers. As explained above the customers 106 may be selected from the list of customers of at least the third-party applications and the existing microsites associated with the server system 200. Based on successful authentication, the microsite generation engine 220 allows the customers 106 and the user 102 to access the microsite and the microsite services, respectively. Additionally, the authentication engine 224 facilitates authentication of the third-party application 122 for providing APIs related to the microsite services associated with the server system 200 to the third-party application server 112.

The recommendation engine 226 includes suitable logic and/or interfaces for providing recommendations to optimize the microsite. More specifically, the recommendation engine 226 in conjunction with the microsite monitoring engine 222 is configured to improve the customer experience with the microsite based at least on the metrics. In an embodiment, the server system 200 may include one or more machine learning (ML) models that are trained with training data related to the microsites. As such, the recommendation engine 226 analyzes the metrics of the customers 106 against their experiences with the microsite. Thereafter, the recommendation engine 226 (with access to the ML models) provides activity updates and recommendations related to the content data and the dynamic microsite elements in the microsite to the creator (i.e., the user 102) of the microsite for assisting the customers 106, thereby leading to better and more predictable and repeatable business outcomes. It is to be noted that the recommendations are instantaneously transmitted to the user 102 based at least on encountering events, for example, negative feedback from the customer or customer apathy.

Further, the recommendation engine 226 may provide recommendations for the microsite by accessing similar types of microsites stored in the database 204. In one scenario, the recommendation engine 226 may provide automated recommendations that can be instantaneously incorporated into the microsite. In this scenario, the recommendation engine 226 may transmit a notification to the user 102 and/or the customers 106 for notifying about the update in the microsite based on the recommendations. In another scenario, the recommendation engine 226 may incorporate the recommendations in the microsite based at least on receipt of a confirmation message from the user 102 through the application 120. It is evident that the continuous monitoring and optimizing of the microsite based on customer preferences conforms to a closed-loop system. The closed-loop system enables the microsite management system 218 to detect a customer's dissatisfaction at an early stage, provide corrective actions (i.e., the recommendations), and continue the monitoring and mentoring the customers 106 during the journey with the microsite associated with the server system 200.

The scoring engine 228 includes suitable logic and/or interfaces for evaluating the feedback score. More specifically, the scoring engine 228 in conjunction with the microsite monitoring engine 222 computes the feedback score for the customers 106 based at least on the one or more metrics determined corresponding to the interaction of each of the customers 106 with the microsite. The feedback score indicates a customer rating (or customer satisfaction benchmark) associated with each of the customers 106 on the microsite. In other words, the feedback score is a research metric that typically takes a survey for receiving the customer rating. For example, the customer may be determined as a detractor for the service, if the feedback score is a negative value (e.g., −100), and the customer may be determined as a promoter of the service if the feedback score is a positive value (e.g., +100). Further, the scoring engine 228 may render the feedback score in the application 120, thereby allowing the creator of the microsite (i.e., the user 102) to track the customer usage on the microsite.

The gamification engine 230 includes suitable logic and/or interfaces for rendering at least one gaming attribute in the microsite to drive microsite engagement. In other words, the gamification engine 230 may account for peer-to-peer recognition and manager recognition of microsite interactions. The gaming attributes (or the game mechanics) allow at least the user 102 and the customers 106 to interact with the dynamic microsite elements (for example, progress bars, graphs, or other metrics-driven elements). Further, the gamification engine 230 is configured to monitor one or more operations performed by each of the customers 106 in the microsite to complete an activity defined in the microsite. The one or more operations are performed by the customers 106 using the gaming attributes. Furthermore, the gamification engine 230 is configured to allocate reward points corresponding to the one or more operations performed by each of the plurality of customers in the microsite in order to complete the activity defined in the microsite. Further, the gamification engine 230 is configured to generate a leaderboard for a particular time period based on the reward points assigned for the microsite corresponding to the operations performed by the customers 106 in the microsite by using the gaming attributes. As such, the leaderboards are made accessible to the user 102 in the application 120.

In an embodiment, the microsite management system 218 may render the feedback score and the leaderboard in the microsite, thereby allowing access to the customers 106. The microsite management system 218 may be configured to track an operating status (either active or inactive) of the microsite on a periodic basis (e.g., 10 days). The operating status is determined based at least on a customer interaction frequency with the microsite ((or the number of customers interacting with the microsite). As a result, the microsite management system 218 eliminates and/or deactivates the microsite based at least on determining the operating status to be inactive. Additionally, the microsite management system 218 may deactivate the microsite based on an expiry date set by the user 102 for the microsite, while creating the microsite. Further, the microsite management system 218 may create analytics based on tracking a number of active microsites, deactivated microsites, and the like.

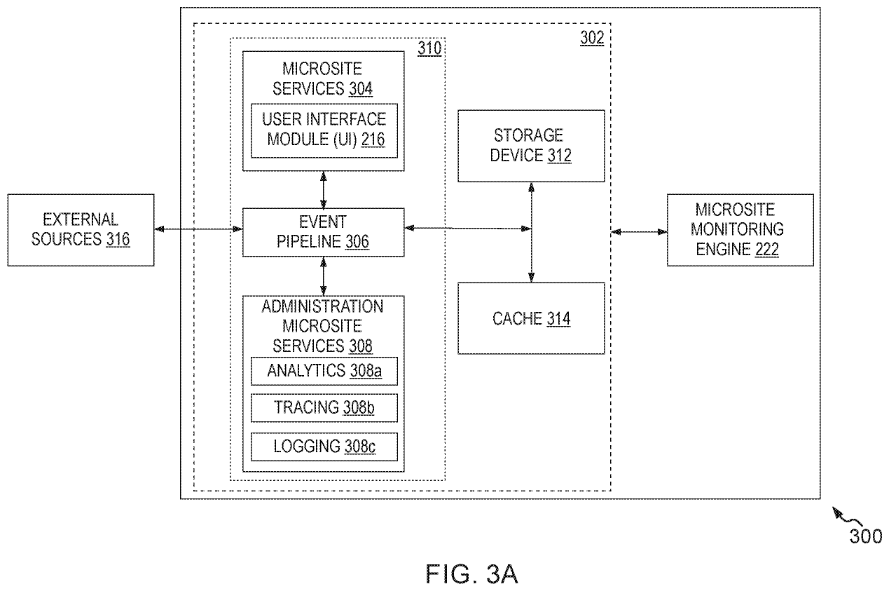

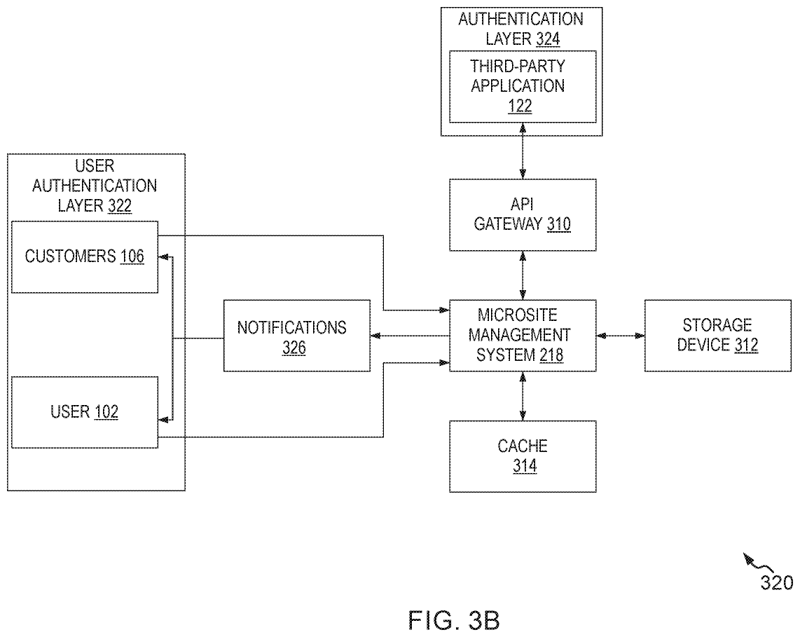

FIG. 2B illustrates a simplified block diagram representation of a system architecture 240 for generating the microsite and monitoring customer experience with the microsite, in accordance with an example embodiment of the present disclosure. The system architecture 240 includes a builder tool 242, a guide tool 244, and an assistant tool 246. The builder tool 242 includes an analytics tool 248, an application dashboard 250, and an experiences tool 252, each coupled to, and in operable communication with a storage component 254 (e.g., the database 114 of FIG. 1). The builder tool 242 further includes an API 256 (i.e., similar to the API gateway 310 explained with reference to FIG. 3A) and a notification engine 258. In one embodiment, each of the builder tool 242, the guide tool 244, the assistant tool 246, the API 256, and the notification engine 258 is coupled to, and in operable communication with the storage component 254.

The analytics tool 248 includes dashboard 248a, reports 248b, and exports 248c. The application dashboard 250 includes content 250a, recommendations 250b, surveys 250c, and gamification interfaces 250d. The experiences tool 252 includes wizard 252a, templates 252b, and components 252c for generating the experiences. The guide tool 244 further includes training 244a, recommendations 244b, and experiences 244c. Furthermore, the assistant tool 246 includes experience list 246a, recommendations list 246b, and content schedules 246c.

The analytics tool 248 enables the microsite management system 118 to provide analytics to the user 102. In one embodiment, the analytics may be viewed on the dashboard 248a or shared in the form of the reports 248b. In one embodiment, the analytics may be converted in form of out-of-the-box reports, or the reports 248b may be created based on a template or format selected by the user 102. In one embodiment, the reports 248b facilitates in the representation of the analytics data in a visual format. Once the reports 248b are generated and finalized, the exports 248c may enable sharing or export of the reports 248b in one or more formats to other components of the system architecture 240.

The application dashboard 250 provides an overarching view of the wizard suite to the user 102. In one embodiment, the application dashboard enables the user 102 to view and/or configure elements such as the content 250a, the recommendations 250b, the surveys 250c, and the gamification interfaces 250d. The content 250a relates to the content data related to the source webpage. The recommendations 250b are provided to improve the customer experience with the microsite based on the metrics. The surveys 250c are examples of the dynamic microsite elements. In one embodiment, the gamification interfaces 250d enable proper and timely running of the gamification engine 224.

The experiences tool 252 includes the wizard 252a (i.e., the wizard suite associated with the microsite services), the templates 252b (i.e., the microsite templates), and other components 252c (e.g., recommendations) necessary for enhancing the customer experience. Further, the API 256 enables the microsite generation engine 220 to provide integration of the microsite services in the third-party application 122. More specifically, the API 256 enables integration of the third-party application 122 with the microsite services without any additional efforts from the user 102.

The notification engine 258 transmits timely notifications to the user 102 and/or the customers 106 for notifying about the update in the microsite based on the recommendations 250b. In one embodiment, the notifications may be transmitted to the user devices 104, 108a-108c to allow the user 102 or the customers 106 to take actions based on the notifications.

In one embodiment, an external content 260 (e.g., from the external sources 416) may be provided to the guide tool 244. The external content 260 may include any content that is not integral to the experience itself but is added as a convenience to the customers 106. For example, external training courses stored in the storage component 254 may be treated as the external content 260. In one example, the storage component 254 (e.g., the database 114 of FIG. 1) may store information related to content 254a, user information 254b, analytics 254c, and experiences 254d. The guide tool 244 includes a guide or step-by-step information related to the training 244a of the user 102 and/or the customers 106, providing recommendations 244b to the user 102 and/or the customers 106, and improving the experiences 244c of the user 102 and/or the customers 106.

The assistant tool 246 includes the experience list 246a to allow the user 102 to view and manage the experiences of all the customers 106. The assistant tool 246 further includes the recommendations list 246b to view all the recommendations that may be sent to the customers 106 to improve their experience based on the metrics. Furthermore, the assistant tool 246 includes the content schedules 246c to schedule the publishing of the microsite to the customers 106 based at least on the temporal restriction.

FIG. 3A illustrates a simplified block diagram representation of a system architecture 300 associated with the microsite management system 218 of FIG. 2A, in accordance with an example embodiment of the present disclosure. The system architecture 300 includes a cluster 302. The cluster 302 includes the user interface (UI) module 216, microsite services 304, an event pipeline 306, administration microsite services 308, an API gateway 310, a storage device 312, and cache 314 (i.e., temporary storage) As shown, the cluster 302 is communicably coupled to the microsite monitoring engine 222 for performing one or more operations described herein.

The UI module 216 interact with the server system 200 in conjunction with the appropriate microsite services such as the microsite services 304. As explained above, the UI module 216 provides access to the microsite services 304 for the user 102. The event pipeline 306 enables the microsite services 304 and the administration microsite services 308 to publish the microsites and subscribe to events. Further, the event pipeline 306 defines rules for transmitting and receiving information from external sources 316 (e.g., the third-party application 122) through the API gateway 310. Further, the administration microsite services 308 allows the user 102 to view analytics 308a, tracing 308b, and logging 308c information and controls the application 120.

FIG. 3B illustrates a simplified block diagram representation 320 depicting integrations of various entities with the microsite management system 218, in accordance with an example embodiment of the present disclosure. The microsite management system 218 in conjunction with the authentication engine 224 may render a user authentication layer 322. The user authentication layer 322 is configured to authenticate the user 102 based on the user roles which corresponds to the access levels in the microsite. Further, the user authentication layer 322 is configured to manage the access of the customers 106 to the microsites to which they have been added by the user 102. The microsite management system 218 is configured to write and read information to and from the cache 314. For instance, the microsite management system 218 may store the state of microsite parameters and metrics in the cache 314, as they are related to microsites and the customers 106. Further, the microsite management system 218 in conjunction with the authentication engine 224 may provide an authentication layer 324. The authentication layer 324 performs authentication of the third-party application 122 for receiving the information and/or a plurality of third-party tools associated with the third-party application 122 through the API gateway 310. Further, the microsite management system 218 is configured to transmit notifications 326 stored in the storage device 312 to the customers 106 through messaging platforms based on the rules defined by the creator (i.e., the user 102) of the microsite. Additionally, the microsite management system 218 transmits the notifications 326 to the user 102 and the customers 106 for notifying the user 102 and the customers 106 about the update in the microsite management system 218 or the microsite based on the recommendations.

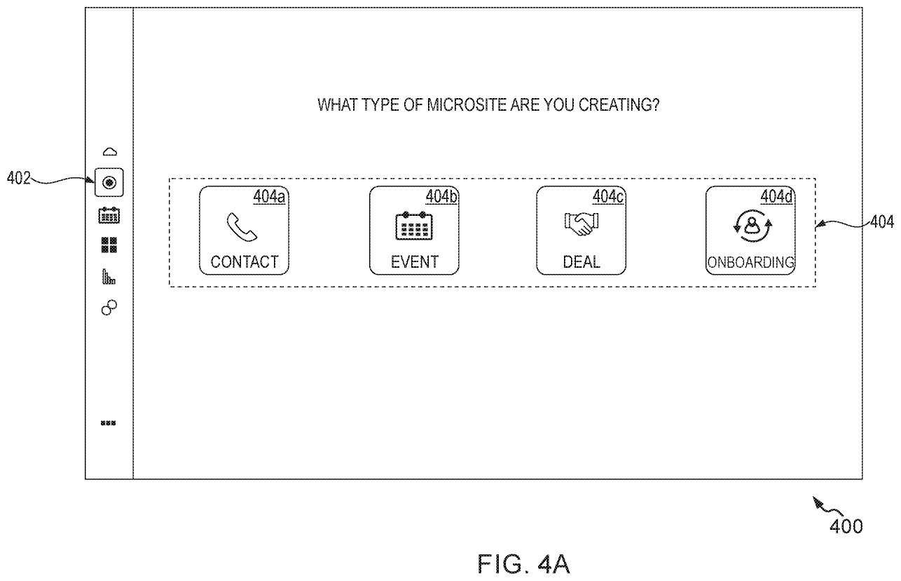

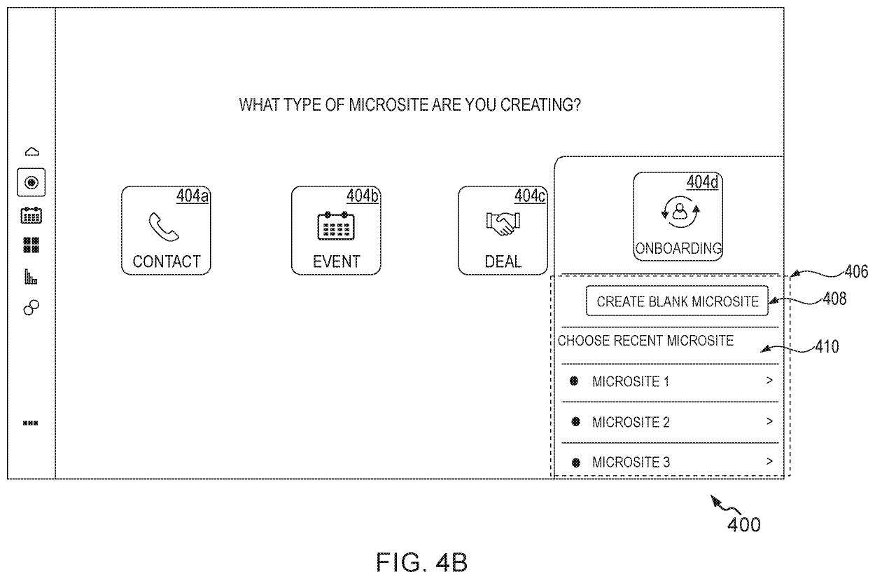

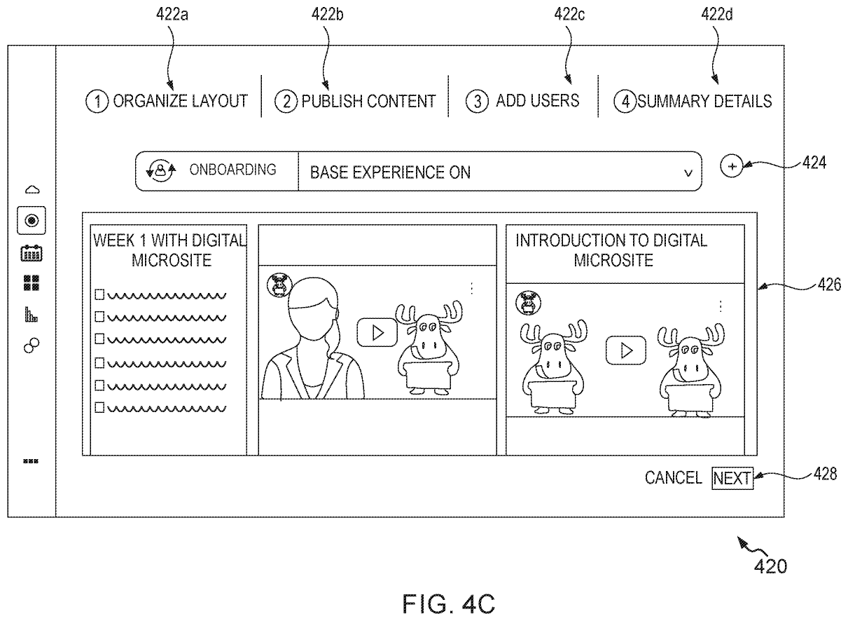

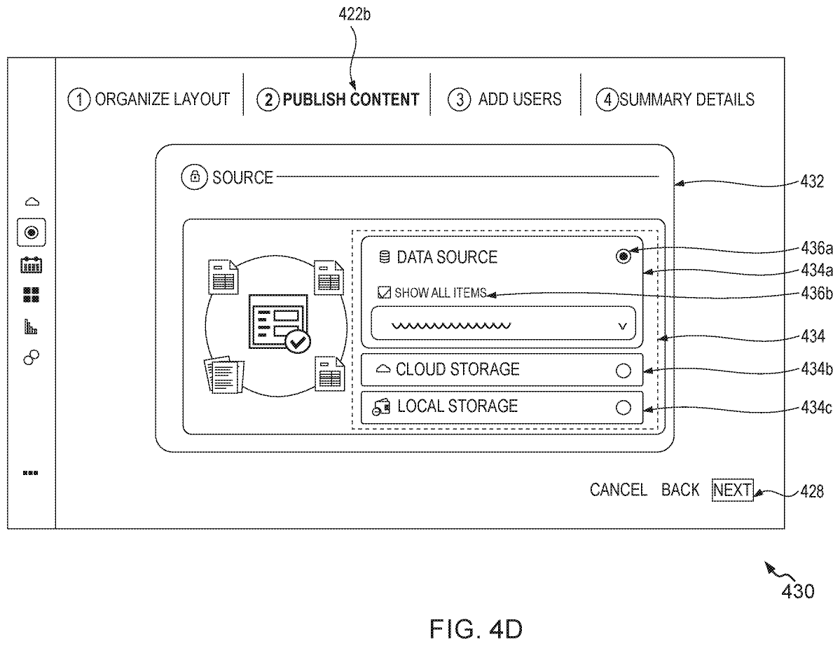

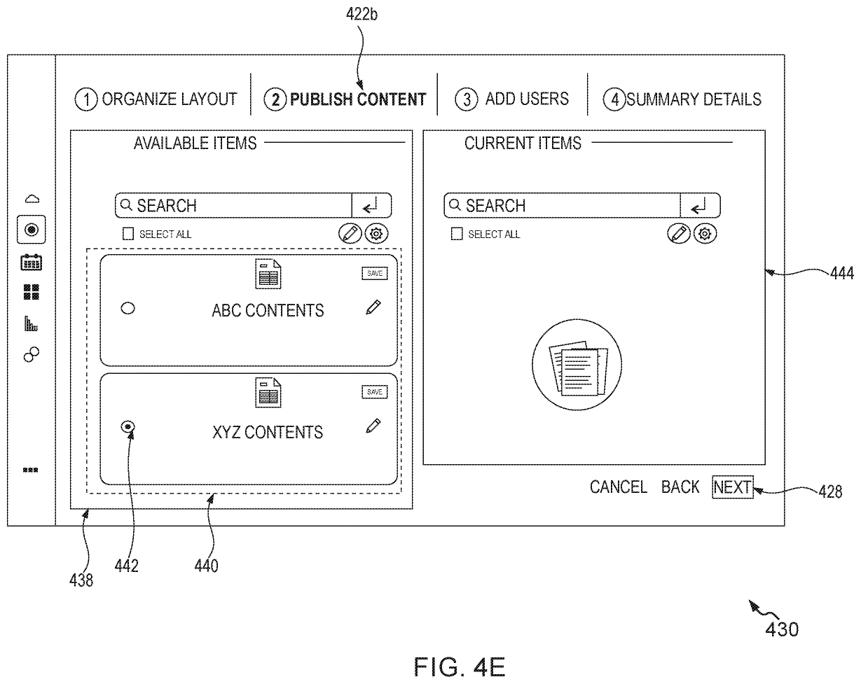

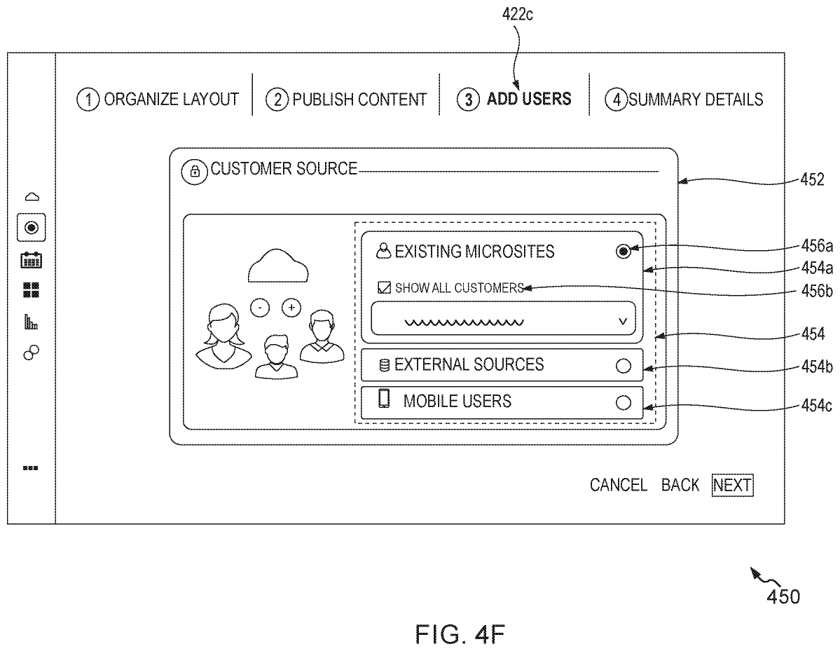

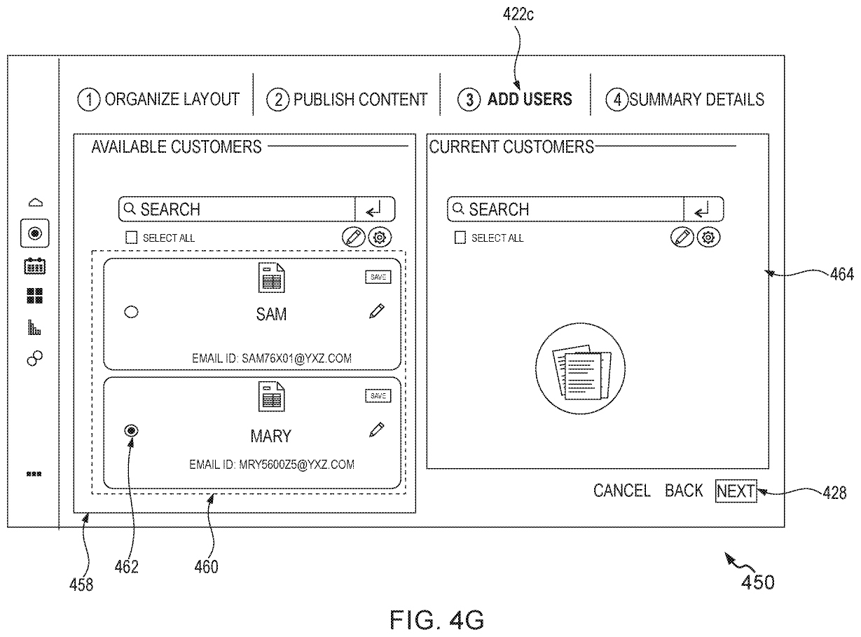

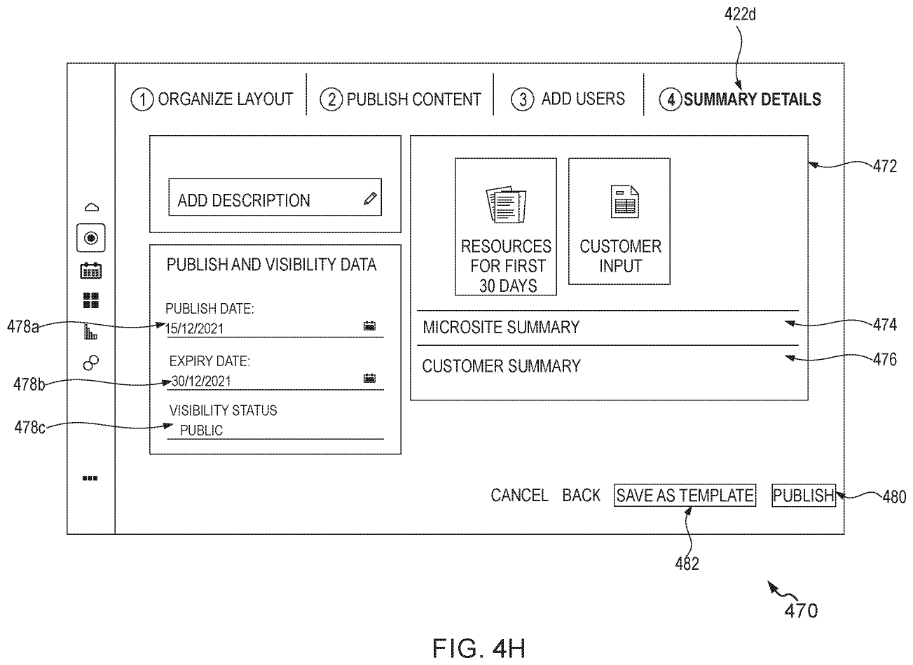

FIGS. 4A-4H, collectively, represent example representation of user interfaces (UIs) rendered in the application 120 for generating the microsite, in accordance with an example embodiment of the present disclosure. The UIs depicted for generating the microsite in the application 120 are rendered to the user 102 based on receipt of the service request from the user 102 as explained above.

Referring now to FIG. 4A, an example representation of a user interface (UI) 400 for receiving inputs related to the microsite type is illustrated. The UI 400 is rendered in the application 120 based at least on user inputs on an actionable icon 402. The UI 400 correspond to a homepage that is rendered by the wizard suite in the application 120. The UI 400 is depicted to include a list of microsite types 404 for user selection. The list of microsite types 404 includes a microsite type 404a, a microsite type 404b, a microsite type 404c, and a microsite type 404d. The microsite types 404a-404d are associated with the text ‘CONTACT’, ‘EVENT’, ‘DEAL’, and ‘ONBOARDING’, respectively. The user 102 selects the microsite type among the microsite types 404a-404d based on the business services and the customer needs.

Referring to FIG. 4B, upon providing a selection input (click or touch input) on any one of the microsite types 404a-404d, the user 102 is prompted with a pop-up menu 406 associated with the corresponding microsite in the UI 400. As shown, the microsite type 404d (i.e., the onboarding microsite type) is selected by the user 102 in the UI 400. As a result, the pop-up menu 406 corresponding to the microsite type 404d is overlaid in the UI 400. The pop-up menu 406 is depicted to include a button 408 associated with the text ‘CREATE BLANK MICROSITE’. The user 102 is directed to a UI 420 (as shown in FIG. 4C) for enabling the user 102 to create a new microsite by using the dynamic microsite elements of the wizard suite. Further, the pop-up menu 406 is depicted to include a list of microsite templates 410. The microsite templates depicted in the list of microsite templates 410 may be the microsites that are recently created by the user 102 in the application 120. The user 102 selects the microsite template from the list of microsite templates 410 rendered in the pop-up menu 406. The user 102 is directed to the UI 420 based on user selection of the microsite template.

Referring to FIG. 4C, the UI 420 is depicted to include a plurality of tabs including a tab 422a, a tab 422b, a tab 422c, and a tab 422d associated with the text ‘ORGANIZE LAYOUT’, ‘PUBLISH CONTENT’, ‘ADD USERS’ and ‘SUMMARY DETAILS’, respectively. It is to be noted that the tab 422a is pre-selected in the UI 420, upon user selection of the microsite template in the UI 400. The tab 422a is depicted to include a plurality of dynamic microsite elements 426. For illustration purposes, the dynamic microsite elements 426 are depicted to include digital microsite tools, a microsite introduction video, and there can be any other microsite elements. The user 102 selects the dynamic microsite elements 426 in the UI 420 for creating the microsite as explained above. Further, the user 102 can organize the microsite layout based on the user devices (e.g., mobile phone, laptop device, etc.) to which the microsite is to be published as explained with reference to FIG. 2A. Additionally, the user 102 may customize the dynamic microsite elements (or user-defined dynamic microsite elements) by providing inputs on an actionable icon 424 in the UI 420. The user 102 may be directed to a UI (not shown in FIGS.) for customizing the dynamic microsite elements. Upon organizing the microsite layout, the user 102 provides input on a button 428 for proceeding to the tab 422b.

Referring to FIG. 4D, an example representation of a user interface (UI) 430 depicting the tab 422b for receiving content data of the source webpage is illustrated. The UI 430 is depicted to include a section 432 associated with the title ‘SOURCE’. The section 432 in the UI 430 includes a list of data sources 434 that stores the content data of the webpage. The list of data sources 434 includes a data source 434a associated with the microsite management system 218, a cloud storage 434b, and a local storage 434c. The user 102 can select a data source among the data sources 434 for inputting the content data to the microsite management system 218. It is to be noted that the user 102 selects the data source from the data sources 434a-434c by providing input in a radio button 436a associated with each of the data sources 434a-434c.

Referring to FIG. 4E, the UI 430 is further depicted to include a section 438 associated with the title ‘AVAILABLE ITEMS’. The section 438 depicts one or more content data 440 associated with each of the data sources 434a-434c. For instance, the user 102 may select the data source 434a of the microsite management system 218. Additionally, the user 102 may provide input in a dialog box 436b for viewing the content data 440 of the data source 434a in the application 120 (as shown in FIG. 4D). The section 438 of the UI 430 is depicted to include a radio button 442 for each of the content data 440 listed in the section 438. The user 102 selects the content data 440 of the source webpage associated with the data source (e.g., the data source 434a) by providing input in the radio button 442. Further, based on user selection of the data sources, for example, the cloud storage 434b or the local storage 434c, the user 102 may be directed to a UI (not shown in FIGS.) for selecting the content data 440 associated with the cloud storage 434b and the local storage 434c. The UI 430 is further depicted to include a section 444 associated with the title ‘CURRENT ITEMS’. The section 444 of the UI 430 is configured to depict the selected content data. The user 102 can scroll between the sections (i.e., the sections 432, 438, and 444) available in the UI 430 for providing the content data 440 to the microsite management system 218. Upon selection of the content data 440, the user 102 provides input on the button 428 for proceeding to the tab 422c.

Referring to FIG. 4F, an example representation of a user interface (UI) 450 depicting the tab 422c for adding users (i.e., the customers 106) to the microsite is illustrated. The UI 450 is depicted to include a section 452 associated with the title ‘CUSTOMER SOURCE’. The section 452 in the UI 430 includes customer sources 454 such as existing microsites 454a associated with the microsite management system 218, external sources 454b (such as third-party applications), and mobile users 454c. The user 102 can select the customers 106 from a list of customers of all the customer sources 454. It is to be noted that the user 102 selects the customer source by providing input in a radio button 456a associated with each of the customer sources 454a-454c.

Referring to FIG. 4G, the UI 450 is further depicted to include a section 458 associated with the title ‘AVAILABLE CUSTOMERS’. The section 458 depicts the list of customers associated with each of the customer sources 454a-454c. For instance, the user 102 may select the customer source as the existing microsites 454a. Additionally, the user 102 may provide input in a dialog box 456b for viewing a list of customers 460 of the existing microsites 454a in the application 120 (as shown in FIG. 4G). The section 458 of the UI 450 is depicted to include a radio button 462 for each customer of the list of customers 460. The user 102 provides input in the radio button 462 to select the customers 106 from the list of customers 460 associated with the existing microsites 454a. Further, the user 102 may be directed to a UI (not shown in FIGS.) depicting the list of customers 460 containing the customers of the external source 454b or the mobile users 454c based on user selection of the external source 454b or the mobile users 454c in the UI 450. The UI 450 is further depicted to include a section 464 associated with the title ‘CURRENT CUSTOMERS’. The section 464 of the UI 430 depicts the selected users from the list of customers 460 of the existing microsites 454a, the external source 454b, and the mobile users 454c. It is to be noted that the user 102 can scroll between the sections (i.e., the sections 452, 458 and 464) available in the UI 450 for providing the customer-related data to the microsite management system 218. Upon selection of the customers 106, the user 102 provides input on the button 428 for proceeding to the tab 422d.

Referring to FIG. 4H, an example representation of a user interface (UI) 470 depicting the tab 422c is illustrated. The UI 470 is depicted to include a summary section 472. The summary section 472 includes a microsite summary 474 and a customer summary 476. The user 102 may access the details pertaining to the microsite and the customer-related details by providing inputs in the microsite summary 474 and the customer summary 476, respectively. Based on user inputs on the microsite summary 474 and the customer summary 476, the user 102 may be prompted with a UI (not shown in FIGS.) to review and confirm the microsite-related details and the customer-related details, respectively. Further, the UI 470 is depicted to include an information field 478a for receiving inputs related to the temporal restriction (or the date for publishing the microsite) an information field 478b for receiving an expiry date of the microsite, and an information field 478c for receiving the visibility status (either public, private or restricted) of the microsite. The UI 470 includes a button 480 and a button 482 associated with the text ‘PUBLISH’, and ‘SAVE AS TEMPLATE’. The UI 470 may include other information fields for receiving inputs related the name of the microsite and the like. The user 102 provides input on the button 480 for publishing the microsite, upon entering the details in the information fields 478a-478c, and confirming the microsite-related details and the customer-related details in the summary section 472. Further, the user 102 can extract the microsite template of the currently generated microsite by providing the input on the button 482. The microsite template extracted from the currently generated microsite is displayed in the list of microsite templates 410.

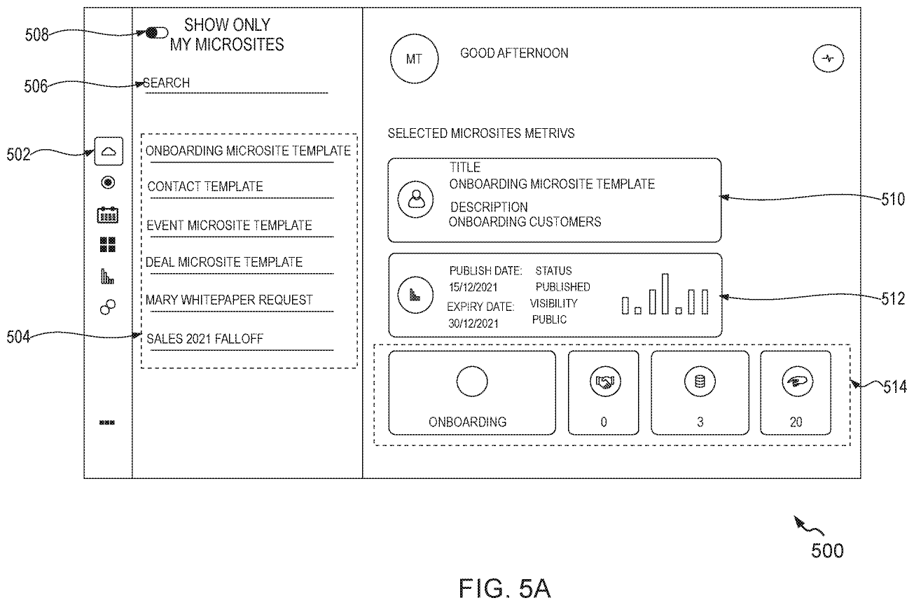

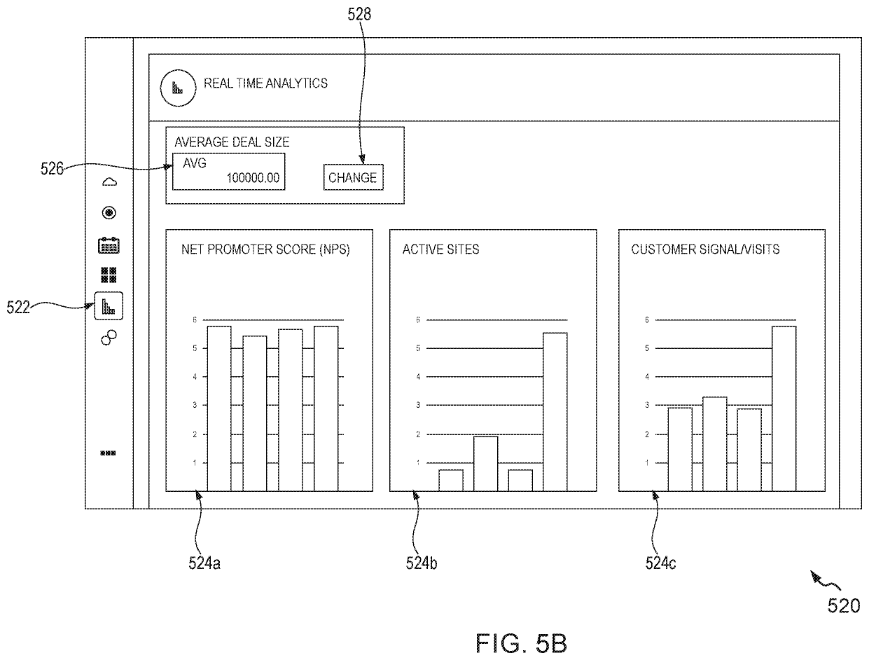

FIGS. 5A and 5B, collectively, represent example representations of user interfaces (Uls) rendered in the application 120 for monitoring the customer experience with the microsite, in accordance with an example embodiment of the present disclosure.

Referring to FIG. 5A, an example representation of a UI 500 is depicted to the user 102 for monitoring the customer experience. The UI 500 is rendered in the application 120 based on user inputs on an actionable icon 502. The UI 500 is depicted to include a list of options 504 including various microsite templates, the published microsites, and the like. The user 102 may provide select an option from the list of options 504 to select the microsite for monitoring the customer experience with the selected microsite. The UI 500 is depicted to include a search field 506. The user 102 may search for the microsite in the list of options 504 by providing inputs related to the keywords of the corresponding microsite in the search field 506. Further, the user 102 may set preferences for viewing the microsite generated by the user 102 using the application 120 by providing input in a toggle switch 508 in the UI 500.

The selected option is rendered in the UI 500 alongside the list of options 504 (as shown in FIG. 5A). The UI 500 is depicted to include a title 510 for depicting the title of the selected option (or the microsite). Further, the UI 500 is depicted to include a data field 512 for depicting information (for example, published date and status, visibility status, and expiry date) pertaining to the selected option (as shown in FIG. 5A). Further, the UI 500 is depicted to include a customer experience section 514 depicting metrics associated with the microsite which are triggered based on the interaction of the customers 106 with the microsite.

Referring to FIG. 5B, an example representation of a UI 520 is depicted to the user 102 for monitoring real-time analytics of all the microsites in the application 120. The UI 520 is rendered in the application 120 based on user inputs on an actionable icon 522. The UI 520 is depicted to include one or more graphical representations such as a graphical representation 524a, a graphical representation 524b, and a graphical representation 524c for depicting analytics of the feedback score, active microsites, customer interactions (visits/signals), respectively. The graphical representations 524a-524c (exemplarily depicted to be a bar graph) where each bar represents the micro site and the bar length of the bar represents the customer interactions with the microsite. Further, the UI 520 is depicted to include a data field 526 for receiving inputs related to a scale of the graphical representations 524a-524c. Upon providing the inputs in the data field 526, the user 102 clicks on a button 528 for implementing the scale in the graphical representations 524a-524c.

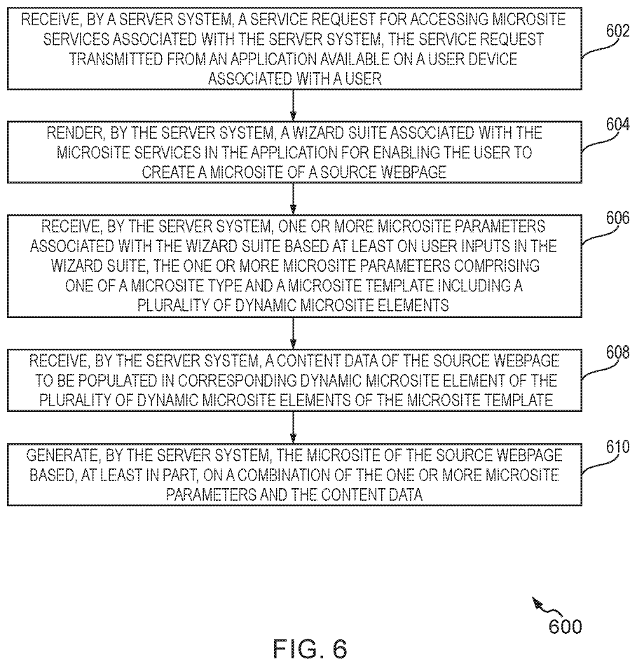

FIG. 6 illustrates a flow diagram of a computer-implemented method 600 for generating the candidate entities from the enterprise documents, in accordance with an embodiment of the present disclosure. The method 600 depicted in the flow diagram may be executed by, for example, the microsite management system 218 of the server system 200. Operations of the flow diagram of the method 600, and combinations of operation in the flow diagram of the method 600, may be implemented by, for example, hardware, firmware, a processor, circuitry, and/or a different device associated with the execution of software that includes one or more computer program instructions. It is noted that the operations of the method 600 can be described and/or practiced by using a system other than these server systems. The method 600 starts at operation 602.

At operation 602, the method 600 includes receiving, by the server system 200, a service request for accessing microsite services associated with the server system 200, The service request is transmitted from the application 120 available on the user device 104 associated with the user 102.

At operation 604, the method 600 includes rendering, by the server system 200, a wizard suite associated with the microsite services in the application 120 for enabling the user 102 to create a microsite of a source webpage.

At operation 606, the method 600 includes receiving, by the server system 200, one or more microsite parameters associated with the wizard suite based at least on user inputs in the wizard suite. The one or more microsite parameters include one of a microsite type and a microsite template including a plurality of dynamic microsite elements.

At operation 608, the method 600 includes receiving, by the server system 200, a content data of the source webpage to be populated in corresponding dynamic microsite element of the one or more dynamic microsite elements of the microsite template.

At operation 610, the method 600 includes generating, by the server system 200, the microsite of the source webpage based, at least in part, on a combination of the one or more microsite parameters and the content data. The description pertaining to the generation of the microsite is already explained in detail with reference to FIG. 2A, and it is not reiterated herein for the sake of brevity.

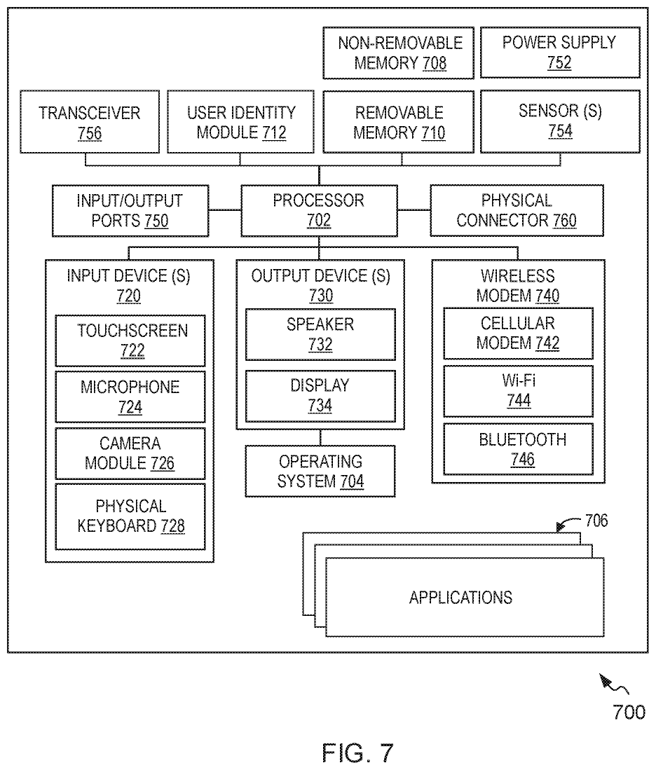

FIG. 7 is a simplified block diagram of an electronic device 700 capable of implementing various embodiments of the present disclosure. For example, the electronic device 700 may correspond to the user devices 104 and 108a-108c of FIG. 1. The electronic device 700 is depicted to include one or more applications 706. For example, the one or more applications 706 may include the application 120 of FIG. 1. The application 120 can be an instance of an application provided by the server system 110 or the server system 200. One of the one or more applications 706 installed on the electronic device 700 is capable of communicating with the server system 200 for generating the microsite and monitoring the customer experience with the microsite.

It should be understood that the electronic device 700 as illustrated and hereinafter described is merely illustrative of one type of device and should not be taken to limit the scope of the embodiments. As such, it should be appreciated that at least some of the components described below in connection with the electronic device 700 may be optional and thus in an embodiment may include more, less, or different components than those described in connection with the embodiment of the FIG. 7. As such, among other examples, the electronic device 700 could be any of a mobile electronic device, for example, cellular phones, tablet computers, laptops, mobile computers, personal digital assistants (PDAs), mobile televisions, mobile digital assistants, or any combination of the aforementioned, and other types of communication or multimedia devices.

The illustrated electronic device 700 includes a controller or a processor 702 (e.g., a signal processor, microprocessor, ASIC, or other control and processing logic circuitry) for performing such tasks as signal coding, data processing, image processing, input/output processing, power control, and/or other functions. An operating system 704 controls the allocation and usage of the components of the electronic device 700 and supports one or more operations of the application (see, the applications 706), such as the application 120 that implements one or more of the innovative features described herein. In addition, the applications 706 may include common mobile computing applications (e.g., telephony applications, email applications, calendars, contact managers, web browsers, messaging applications) or any other computing application.

The illustrated electronic device 700 includes one or more memory components, for example, a non-removable memory 708 and/or removable memory 710. The non-removable memory 708 and/or the removable memory 710 may be collectively known as a database in an embodiment. The non-removable memory 708 can include RAM, ROM, flash memory, a hard disk, or other well-known memory storage technologies. The removable memory 710 can include flash memory, smart cards, or a Subscriber Identity Module (SIM). The one or more memory components can be used for storing data and/or code for running the operating system 904 and the applications 706. The electronic device 700 may further include a user identity module (UIM) 712. The UIM 712 may be a memory device having a built-in processor . The UIM 712 may include, for example, a subscriber identity module (SIM), a universal integrated circuit card (UICC), a universal subscriber identity module (USIM), a removable user identity module (R-UIM), or any other smart card. The UIM 712 typically stores information elements related to a mobile subscriber. The UIM 712 in form of the SIM card is well known in Global System for Mobile (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The electronic device 700 can support one or more input devices 720 and one or more output devices 730. Examples of the input devices 720 may include, but are not limited to, a touch screen/a display screen 722 (e.g., capable of capturing finger tap inputs, finger gesture inputs, multi-finger tap inputs, multi-finger gesture inputs, or keystroke inputs from a virtual keyboard or keypad), a microphone 724 (e.g., capable of capturing voice input), a camera module 726 (e.g., capable of capturing still picture images and/or video images) and a physical keyboard 728. Examples of the output devices 730 may include, but are not limited to, a speaker 732 and a display 734. Other possible output devices can include piezoelectric or other haptic output devices. Some devices can serve more than one input/output function. For example, the touch screen 722 and the display 734 can be combined into a single input/output device.

A wireless modem 740 can be coupled to one or more antennas (not shown in FIG. 7) and can support two-way communications between the processor 702 and external devices, as is well understood in the art. The wireless modem 740 is shown generically and can include, for example, a cellular modem 742 for communicating at long range with the mobile communication network, a Wi-Fi compatible modem 744 for communicating at short range with an external Bluetooth-equipped device, or a local wireless data network or router, and/or a Bluetooth-compatible modem 746. The wireless modem 740 is typically configured for communication with one or more cellular networks, such as a GSM network for data and voice communications within a single cellular network, between cellular networks, or between the electronic device 700 and a public switched telephone network (PSTN).

The electronic device 700 can further include one or more input/output ports 750, a power supply 752, one or more sensors 754 for example, an accelerometer, a gyroscope, a compass, or an infrared proximity sensor for detecting the orientation or motion of the electronic device 700 and biometric sensors for scanning biometric identity of an authorized user, a transceiver 756 (for wirelessly transmitting analog or digital signals) and/or a physical connector 760, which can be a USB port, IEEE 1294 (FireWire) port, and/or RS-232 port. The illustrated components are not required or all-inclusive, as any of the components shown can be deleted and other components can be added.

The disclosed method with reference to FIG. 6, or one or more operations of the server system 200 may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components)) and executed on a computer (e.g., any suitable computer, such as a laptop computer, netbook, Webbook, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means includes, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal-oxide semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, application-specific integrated circuit (ASIC) circuitry and/or in Digital Signal Processor (DSP) circuitry).

Particularly, the server system 200 and its various components may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer-readable media. Non-transitory computer-readable media include any type of tangible storage media. Examples of non-transitory computer-readable media include magnetic storage media (such as floppy disks, magnetic tapes, hard disk drives, etc.), optical magnetic storage media (e.g., magneto-optical disks), CD-ROM (compact disc read-only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the disclosure, as discussed above, may be practiced with steps and/or operations in a different order, and/or with hardware elements in configurations, which are different than those which are disclosed. Therefore, although the disclosure has been described based upon these exemplary embodiments, it is noted that certain modifications, variations, and alternative constructions may be apparent and well within the spirit and scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method, comprising:
receiving, by a server system, a service request for accessing microsite services associated with the server system, the service request transmitted from an application available on a user device associated with a user;
rendering, by the server system, a wizard suite associated with the microsite services in the application for enabling the user to create a microsite of a source webpage;
receiving, by the server system, one or more microsite parameters associated with the wizard suite based at least on user inputs in the wizard suite, the one or more microsite parameters comprising one of a microsite type and a microsite template including a plurality of dynamic microsite elements;
receiving, by the server system, a content data of the source webpage to be populated in corresponding dynamic microsite element of the plurality of dynamic microsite elements of the microsite template; and
generating, by the server system, the microsite of the source webpage based, at least in part, on a combination of the one or more microsite parameters and the content data.

2. The computer-implemented method as claimed in claim 1, further comprising:
receiving, by the server system, inputs related to a plurality of customers from the wizard suite, the plurality of customers being selected from a list of customers of existing microsites associated with the server system and third-party applications; and
rendering, by the server system, the microsite at the user device associated with each of the plurality of customers through integrated application programming interface (API) services, thereby providing effective handoff from sales to service to the plurality of customers.

3. The computer-implemented method as claimed in claim 2, wherein rendering the microsite to the plurality of customers comprises:
performing, by the server system, authentication of the plurality of customers being selected by the user from the list of customers of the third-party applications and the existing microsites associated with the server system based, at least in part, on credentials associated with each of the plurality of customers; and
facilitating, by the server system, enabling access to the microsite for each of the plurality of customers, upon successful authentication of the credentials associated with each of the plurality of customers.

4. The computer-implemented method as claimed in claim 1, further comprising:
receiving, by the server system, a service request for converting the microsite belonging to a particular microsite type into another microsite belonging to other microsite type.

5. The computer-implemented method as claimed in claim 1, further comprising:
monitoring continuously, by the server system, one or more metrics associated with the microsite based, at least in part, on interaction of at least the user and a plurality of customers with the microsite, the one or more metrics comprising one of a login time to the microsite, an active duration in the microsite and document related operations performed in the microsite;
transmitting instantaneously, by the server system, recommendations related to the content data and the plurality of dynamic microsite elements in the microsite to the user for assisting the plurality of customers based at least on analyzing the one or more metrics associated with the microsite; and
applying, by the server system, the recommendations to the microsite based at least on receipt of a confirmation message from the user through the application.

6. The computer-implemented method as claimed in claim 5, wherein updating the microsite with the recommendations related to the content data and the plurality of dynamic microsite elements comprises:
evaluating, by the server system, a feedback score indicative of a customer rating associated with each of the plurality of customers on the microsite, wherein the feedback score associated with each of the plurality of customers is computed based at least on the one or more metrics determined corresponding to the interaction of each of the plurality of customers with the microsite.

7. The computer-implemented method as claimed in claim 1, further comprising:
rendering, by the server system, at least one gaming attribute in the microsite to drive interaction of a plurality of customers with the plurality of dynamic microsite elements of the microsite;
monitoring, by the server system, one or more operations performed in the microsite by each of the plurality of customers for completing an activity defined in the microsite, the one or more operations performed using the at least one gaming attribute; and
allocating, by the server system, reward points corresponding to the one or more operations performed by each of the plurality of customers in the microsite in order to complete the activity defined in the microsite.

8. The computer-implemented method as claimed in claim 2, wherein rendering the microsite to the plurality of customers comprises:
receiving, by the server system, inputs related to a visibility status, an expiry date and a temporal restriction, the temporal restriction being set by the user for an operation related to rendering the microsite to the plurality of customers.

9. The computer-implemented method as claimed in claim 8, further comprising:
facilitating, by the server system, rendering of the microsite to the plurality of customers based, at least in part, the temporal restriction set for the corresponding operation, the temporal restriction including a date for rendering the microsite.

10. The computer-implemented method as claimed in claim 9, further comprising:
tracking, by the server system, an operating status associated with the microsite on a periodic basis based at least on a customer interaction frequency with the microsite, the operating status associated with the microsite being one of an active and inactive; and
facilitating, by the server system, deactivation of the microsite based at least on:
determining the operating status of the microsite to be inactive, and
the expiry date associated with the microsite.

11. A server system, comprising:
a communication interface;
a memory comprising executable instructions; and
a processor communicably coupled to the communication interface and the memory, the processor configured to cause the server system to perform at least:
receive a service request for accessing microsite services associated with the server system, the service request transmitted from an application available on a user device associated with a user,
render a wizard suite associated with the microsite services in the application for enabling the user to create a microsite of a source webpage,
receive one or more microsite parameters associated with the wizard suite based at least on user inputs in the wizard suite, the one or more microsite parameters comprising one of a microsite type and a microsite template including a plurality of dynamic microsite elements,
receive a content data of the source webpage to be populated in corresponding dynamic microsite element of the plurality of dynamic microsite elements of the microsite template, and
generate the microsite of the source webpage based, at least in part, on a combination of the one or more microsite parameters and the content data.

12. The server system as claimed in claim 11, wherein the server system is further configured to:
receive inputs related to a plurality of customers from the wizard suite, the plurality of customers being selected from a list of customers of existing microsites associated with the server system and third-party applications; and
render the microsite at the user device associated with each of the plurality of customers through integrated application programming interface (API) services, thereby providing effective handoff from sales to service to the plurality of customers.

13. The server system as claimed in claim 12, wherein the server system is configured to:
perform authentication of the plurality of customers being selected by the user from the list of customers of the third-party applications and the existing microsites associated with the server system based, at least in part, on credentials associated with each of the plurality of customers; and
facilitate enabling access to the microsite for each of the plurality of customers, upon successful authentication of the credentials associated with each of the plurality of customers.

14. The server system as claimed in claim 11, further comprising:
receiving, by the server system, a service request for converting the microsite belonging to a particular microsite type into another microsite belonging to other microsite type.

15. The server system as claimed in claim 11, wherein the server system is configured to:
monitor continuously, one or more metrics associated with the microsite based, at least in part, on interaction of at least the user and a plurality of customers with the microsite, the one or more metrics comprising one of a login time to the microsite, an active duration in the microsite and document related operations performed in the microsite;
transmit instantaneously, recommendations related to the content data and the plurality of dynamic microsite elements in the microsite to the user for assisting the plurality of customers based at least on analyzing the one or more metrics associated with the microsite; and
apply the recommendations to the microsite based at least on receipt of a confirmation message from the user through the application.

16. The server system as claimed in claim 15, wherein the server system is further caused to:
evaluate a feedback score indicative of a customer rating associated with each of the plurality of customers on the microsite, wherein the feedback score associated with each of the plurality of customers is computed based at least on the one or more metrics determined corresponding to the interaction of each of the plurality of customers with the microsite.

17. The server system as claimed in claim 11, wherein the server system is further caused to:
render at least one gaming attribute in the microsite to drive interaction of a plurality of customers with the plurality of dynamic microsite elements of the microsite;
monitor one or more operations performed in the microsite by each of the plurality of customers for completing an activity defined in the microsite, the one or more operations performed using the at least one gaming attribute; and
allocate reward points corresponding to the one or more operations performed by each of the plurality of customers in the microsite in order to complete the activity defined in the microsite.

18. The server system as claimed in claim 12, wherein the server system is further caused to:
receive one or more inputs related to a visibility status, an expiry date, and a temporal restriction, the temporal restriction being set by the user for an operation related to rendering the microsite to the plurality of customers.

19. The server system as claimed in claim 18, wherein the server system is further caused to:
facilitate rendering of the microsite to the plurality of customers based, at least in part, the temporal restriction set for the corresponding operation, the temporal restriction including a date for rendering the microsite.

20. The server system as claimed in claim 19, wherein the server system is further caused to:
track an operating status associated with the microsite on a periodic basis based at least on a customer interaction frequency with the microsite, the operating status associated with the microsite being one of an active and inactive; and
facilitate deactivation of the microsite based at least on:
determining the operating status of the microsite to be inactive, and
the expiry date associated with the microsite.
